(19) United States
(12) Patent Application Publication
(10) Pub. No.: US 2005/0226307 A1
(43) Pub. Date: Oct. 13, 2005

(54) Infrared thermometer

(76) Inventors: Sherin Lussier, North Providence, RI (US); Dalita R. Tomellini, Rehoboth, MA (US); Melinda Penney, Providence, RI (US)

Correspondence Address: FISH & RICHARDSON PC, P.O. BOX 1022, MINNEAPOLIS, MN, 55440-1022, US

(21) Appl. No.: 10/819,433

(22) Filed: Apr. 7, 2004

(51) Int. Cl. G01K 7/00; G01K 1/00

(52) U.S. Cl. 374/131; 374/208

(57) ABSTRACT

Oral infrared thermometers are provided. Some preferred thermometers include a spacer configured to preset the distance from the infrared sensor to the oral hot spot to calibrate the electronics of the thermometer for an accurate reading.

### BACKGROUND OF THE INVENTION

This invention relates generally to apparatus for electronically measuring the temperature of a living body, and more particularly, to a thermometer that exhibits enhanced conformity to the anatomy of a human being, especially in and around the mouth.

The basic mercury thermometer has been the standard for measuring body temperature for decades and is known virtually throughout the world. It consists of a hollow glass rod with a bulb of mercury at one end and a temperature scale along the glass rod. Typically, it is inserted into the mouth of a human being and is left in place for three or more minutes. Errors can of course be made in reading the temperature from the scale. Care and a certain amount of patience and expertise are required for proper and accurate use.

From the patient's viewpoint, this form of thermometer is awkward because the thermometer must be held under the tongue and the linear probe is uncomfortable. Anatomically, human beings have a spot under the tongue, often referred to as the hot spot, located on the floor of the mouth, under the tongue, in the rear portion of the mouth. Oral temperature readers target this area of the mouth. The temperature sensing tip of the oral thermometer must be held in the proper position under the tongue. However, the straight thermometer probe is uncomfortable to hold in place at the proper position and is often dislodged by the patient when the patient shifts the probe around inside the mouth in an attempt to ease the discomfort caused by the linear probe. This dislodging of the temperature sensing tip from the correct position increases the time it takes to get an accurate reading.

Electronic thermometers have been introduced which emulate the linear structure of the basic mercury thermometer. A numerical display is usually disposed on electronic thermometers to assist in reading the measured temperature. Electronic thermometers also avoid any potential mercury exposure issues associated with a mercury thermometer. However, these linear electronic thermometers exacerbate the problems of keeping the tip of the thermometer in proper position under the tongue due to the increased weight and mass of the enlarged housing at the opposite end of the thermometer. This problem can be particularly acute in patients unused to, or uncooperative in, having their temperature taken, such as children or the elderly.

Infrared thermometers have been introduced into the market place. Typically, these types of thermometers are designed to measure a person's temperature tympanically, that is, inside the ear canal of a patient. Infrared technology allows a thermometer to take a temperature reading with great speed, often in mere seconds. However, in order to take the temperature reading accurately, the temperature sensing tip of the device must be precisely placed in the correct position within the ear canal. The infrared sensing device and the temperature sensing end of the ear infrared thermometers generally must be positioned at a correct angle (that could be different from person to person) in order to project the infrared beam directly on the tympanic membrane, i.e., the otic hot spot. Since the otic hot spot cannot be seen or felt by the patient or caregiver during the process of taking the temperature, it is difficult to be sure that the temperature is accurately read.

Additionally, ear infrared temperature thermometers are constructed and calibrated such that the temperature sensing end of the probe must be a defined distance away from the ear drum in order for the infrared sensing beams to properly bounce off of the target area in the ear and back to the sensing tip of the probe to ultimately produce an accurate reading. Precise positioning (angle of tip and distance from hot spot) of the thermometer within the ear of a patient may be difficult to achieve. Because these ear thermometers tend to be invasive and difficult to position correctly within the ear, the speed and accuracy of reading the temperature of the patient is often compromised. Moreover, the designs of these tympanic thermometers often are bulky, difficult to use and may produce inaccurate and irregular readings of temperature. In some ear thermometers, the temperature sensing probe is relatively large and thus may be uncomfortable to place inside the ear, especially when the patient is suffering from an ear ailment that renders the inner and/or outer ear painful and sensitive to the touch.

### SUMMARY OF THE INVENTION

The present invention provides an oral thermometer with improved positioning of the temperature-sensing tip under the tongue of a patient combined with infrared temperature taking technology to provide accuracy and speed to the temperature reading and comfort to the patient. A temperature-sensing tip is disposed to be positioned under the tongue of a patient and in contact with the floor of the mouth and the temperature taking device utilizes infrared technology at the temperature sensing tip.

In one aspect, the present invention features a thermometer that includes a housing constructed to be held by a user; a probe, extending from the housing, having an insertable portion constructed for insertion into the mouth of a patient; an infrared sensor, mounted on the probe, for obtaining data indicative of the patient's temperature; and a spacer, surrounding the insertable portion of the probe, the spacer being configured to preset the distance from the infrared sensor to the oral hot spot of the patient.

Some implementations include one or more of the following features. The thermometer also includes a metal tube extending from a first end adjacent the sensor to a second end between the sensor and an end of the insertable portion. The length of the spacer, measured from the second end of the tube to the end of the insertable portion, is from about 6 to 30 mm. The spacer is formed of a clear plastic, e.g., polycarbonate. The total length of the thermometer inserted into the patient's mouth during use is about 40 to 60 mm, e.g., about 50 mm. The outer diameter of the spacer is from about 4 to 12 mm. The spacer has an angled tip.

In another aspect, the invention features using the thermometers described herein to take the temperature of a patient. For example, the invention features a method of measuring the temperature of a patient, including providing a thermometer including (a) a probe having an insertable portion constructed for insertion into the mouth of the patient, (b) an infrared sensor, mounted on the probe, for obtaining data indicative of the patient's temperature, and (c) a spacer, surrounding the insertable portion of the probe, the spacer being configured to preset the distance from the infrared sensor to the oral hot spot of the patient; and inserting the insertable portion into the mouth of the patient. The thermometer may further include a digital display that displays the data obtained by the sensor, and the method may include reading the display.

Some implementations include one or more of the following advantages. Because the oral hot spot can be seen and felt by the patient or caregiver, the caregiver can easily properly position the infrared sensor in relation to the hot spot. The spacer will preset the distance from the infrared sensor to the oral hot spot, to calibrate the electronics for a highly accurate reading. The tip of the spacer can be placed directly on the hot spot so the patient can be sure that the thermometer probe is correctly positioned, assuring an accurate temperature reading. Because the probe can be readily correctly positioned, generally the caregiver will not need to take several readings to corroborate the temperature data. Because the area of the oral hot spot is relatively large and the angle of the probe is predetermined by the spacer, an accurate temperature reading can be readily obtained. The spacer can be made from clear material, such as polycarbonate, to allow the infrared beam to pass through the spacer material and bounce off the oral hot spot. Due to the oral nature of this thermometer, it is not necessary to touch an ear that may be inflamed or sensitive due to ear infection or other ailment. A temperature reading can be obtained quickly, e.g., within one second or less, and with minimum discomfort to the patient.

The term “patient,” as used herein, refers to any human being or mammal whose temperature is to be taken, in any setting, regardless of whether the patient is sick or well. The temperature may be taken by the patient him or herself, or by a caretaker, e.g., a nurse, physician, or family member.

Other features and advantages of the present invention will be apparent from the description and drawings, and from the claims.

### BRIEF DESCRIPTION OF THE DRAWINGS

FIG. 1 is top view of an oral thermometer;

FIG. 2 is a bottom view of the oral thermometer shown in FIG. 1;

FIG. 3 is a side view of the oral thermometer shown in FIG. 1;

FIGS. 4a-4d are sectional views of several alternative configurations of an integral spacer and sensing tip of the infrared oral thermometer probe;

FIG. 5 is a diagrammatic side view of the oral thermometer of FIG. 1 positioned within the mouth of a human being;

FIG. 6 is a side view of an oral thermometer with a pivoting probe.

FIG. 7 is a top view of a battery recharging base for use with a rechargeable oral thermometer.

FIG. 8 is a side view of a rechargeable oral thermometer positioned in the battery recharging base shown in FIG. 7;

FIG. 9 is a bottom view of the rechargeable oral thermometer shown in FIG. 8.

### DETAILED DESCRIPTION OF THE INVENTION

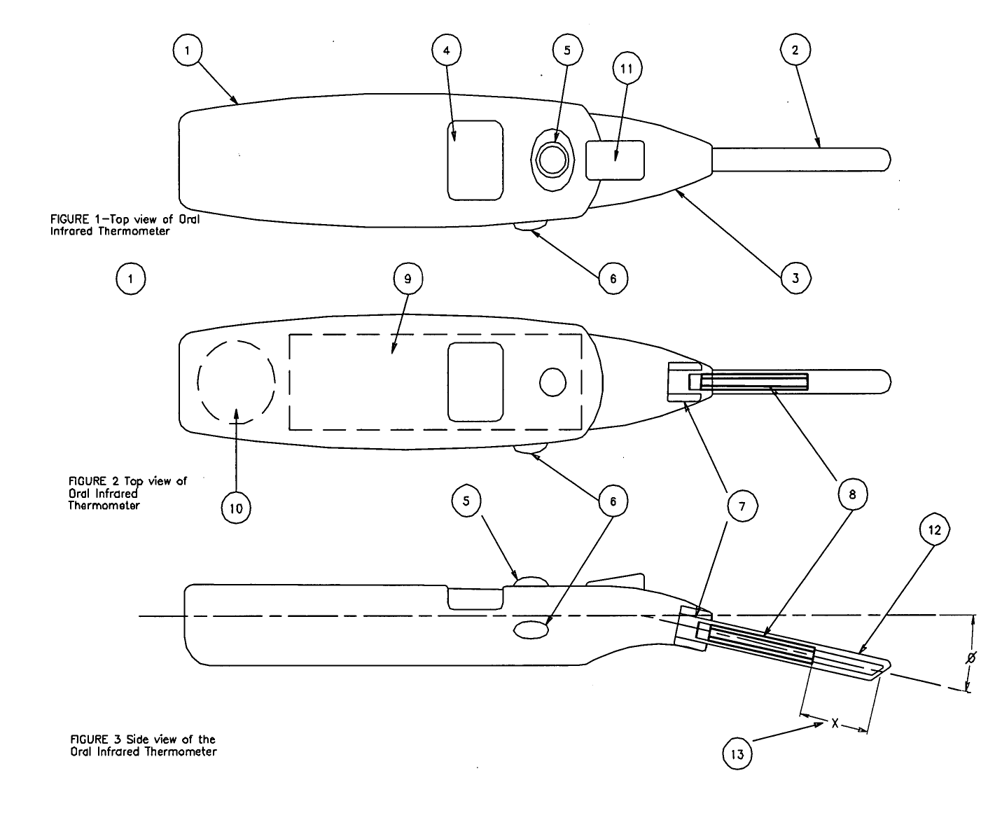

The various drawing figures will now be referred to in detail. Turning first to FIG. 1, an oral thermometer, which is especially suitable for measuring the body temperature of human being by taking a temperature measurement in the mouth, is generally depicted. The illustrated digital thermometer includes a housing 1, a probe 2, a neck portion of the probe 3, and a display 4 (e.g., an LCD screen) in the housing. Multiple switches 5 and 6 are manually operable to electrically activate or deactivate the thermometer. For example, switches 5 and 6 may be of the pushbutton type. The housing 1 is shaped to be compact and to comfortably conform to the hand of a human being.

As can be seen in FIG. 2, the probe 2 has an infrared temperature sensor 7 and an interior metal tube 8 that allows the infrared sensor to take the temperature reading. An electronic circuitry board 9 is located within the housing of the thermometer as is a battery 10.

FIG. 3 shows one alternative positioning of a side activation button 6 and a top activation button 5 as well as a triggering mechanism 11 (FIG. 1) located on the neck portion of the probe and used to mechanically eject a disposable probe cover. The triggering mechanism 11 may be, for example, a spring-loaded lever mechanism designed to snap-on and release the probe cover when actuated.

The oral thermometer also includes a spacer 12 within the tip of the sensing probe (best seen in FIG. 3). Spacer 12 is permanently mounted on the probe and is preferably hermetically sealed thereto, to prevent ingress of contaminents. The spacer has a length X (dimension 13) selected so that the sensing tip of the probe will rest comfortably on the hot spot located under the patient's tongue. As a result, the spacer properly calibrates the infrared reading of the temperature of the hot spot. The length of the spacer is selected to allow the infrared beams from the infrared temperature sensor 7 to bounce back and forth within the inner metal tube 8 as necessary to take an accurate temperature reading. For optimal accuracy, the infrared sensor must be calibrated for the exact length of the spacer. The spacer is also preferably small enough so that the probe will comfortably fit into and conform to the mouth of the patient, and will be comfortable under the tongue of the patient. Different sized thermometers, with different length spacers, may be provided for infants, children and adults, if desired. Preferably, the spacer is between 6 and 30 millimeters long (length X) for best fit in the mouth. The probe may, however, be longer if desired. It is also preferred that the spacer be sufficiently long so that the infrared sensor will be outside of the patient's mouth during use. This prevents the patient from having to open his or her mouth wide enough to accommodate the wider sensor. Moreover, keeping the mouth as closed as possible will minimize cooling in the mouth which could temporarily alter the temperature and thus the accuracy of the reading.

The outer diameter of the spacer is selected to be large enough for the infrared ray to pass through, but not so large that the spacer is uncomfortable in the patient's mouth. Generally, the outer diameter will be from about 4 to 12 mm, e.g., about 5 to 7 mm.

Preferably, the spacer is made of polycarbonate or other transparent plastic, so that the infrared beam may pass through the spacer and bounce off of the oral hot spot. The material should be hard enough so that it cannot be bitten through by the patient. The inner wall of the spacer should be relatively straight (in the axial direction) so that the infrared ray is not obstructed. The spacer may have any desired cross-sectional shape, e.g., circular, oval or elliptical. Preferably the edges of the probe have a curvature to enhance patient comfort.

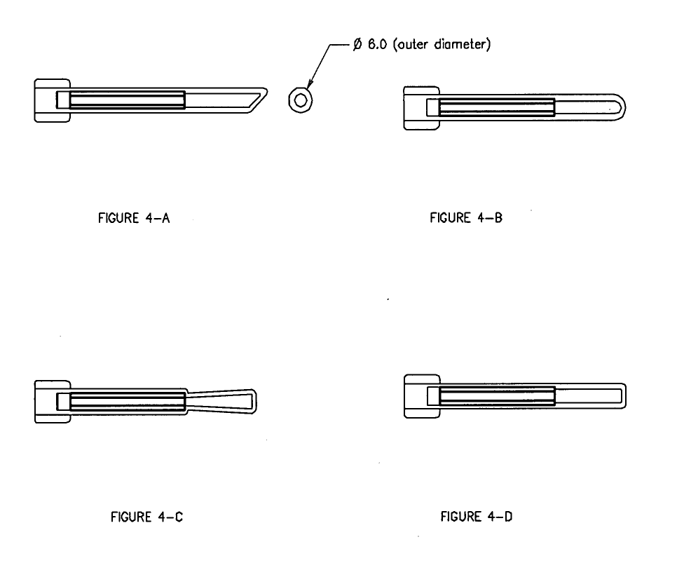

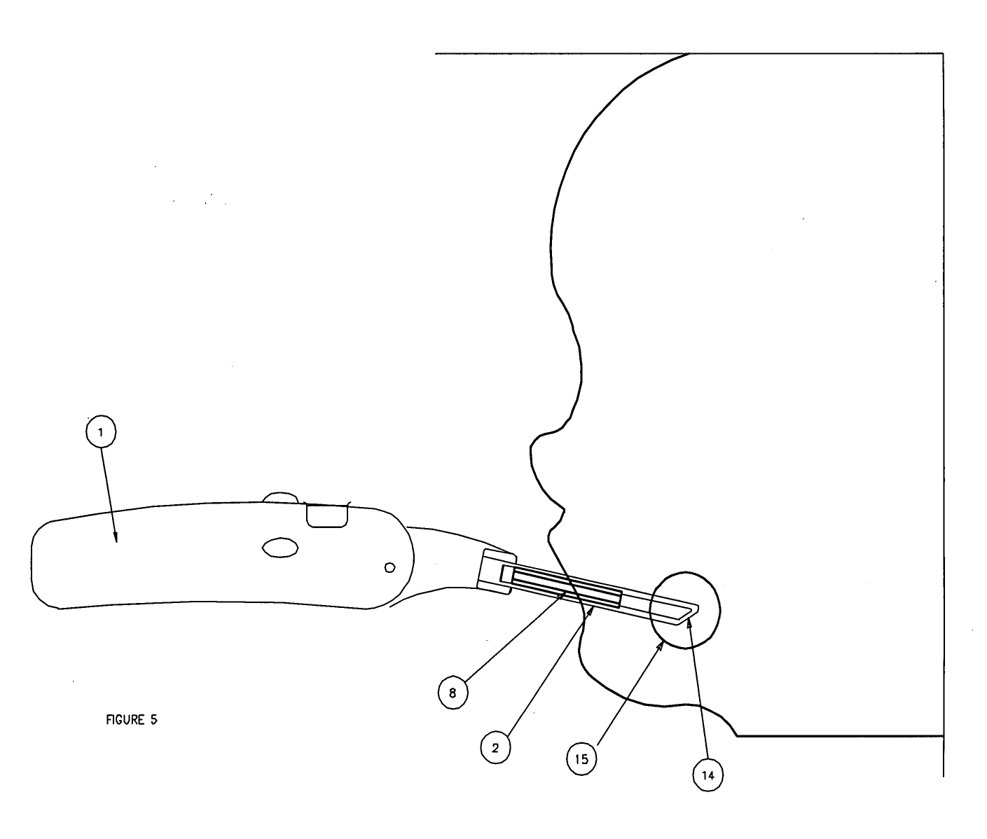

FIG. 4a-4d depicts several embodiments of the temperature sensing probe with differing sensing tip shapes that conform to the anatomy of the patient's mouth and fit comfortably on the hot spot in a person's mouth. As shown, the tip may be angled (FIG. 4a), rounded (FIG. 4b), flat with flared sides (FIG. 4c) or generally rectangular in cross-section (FIG. 4d).

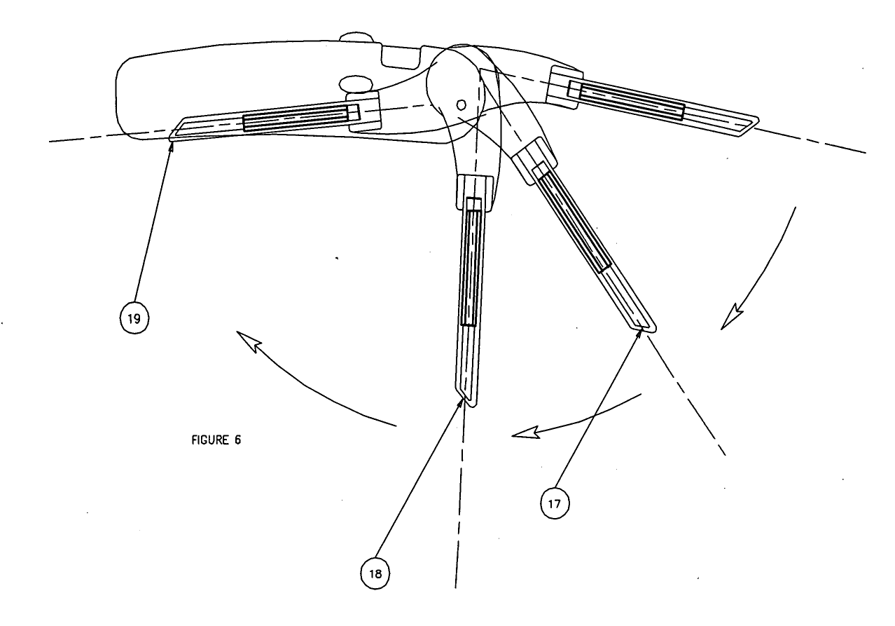

FIG. 5 depicts the positioning of the infrared oral thermometer within the mouth of a human. The end of the probe comfortably conforms to and rests upon the hot spot under the tongue 15. The probe 2 protrudes from the mouth of the patient at an upward, comfortable angle. The housing of the thermometer 1 preferably extends generally perpendicular to the patient, as shown. Preferably, the angle is between about 20 and 60 degrees, e.g., about 35 to 45 degrees. Angles within this range allow the patient to comfortably open his or her mouth and allow the probe to directly access the hot spot.

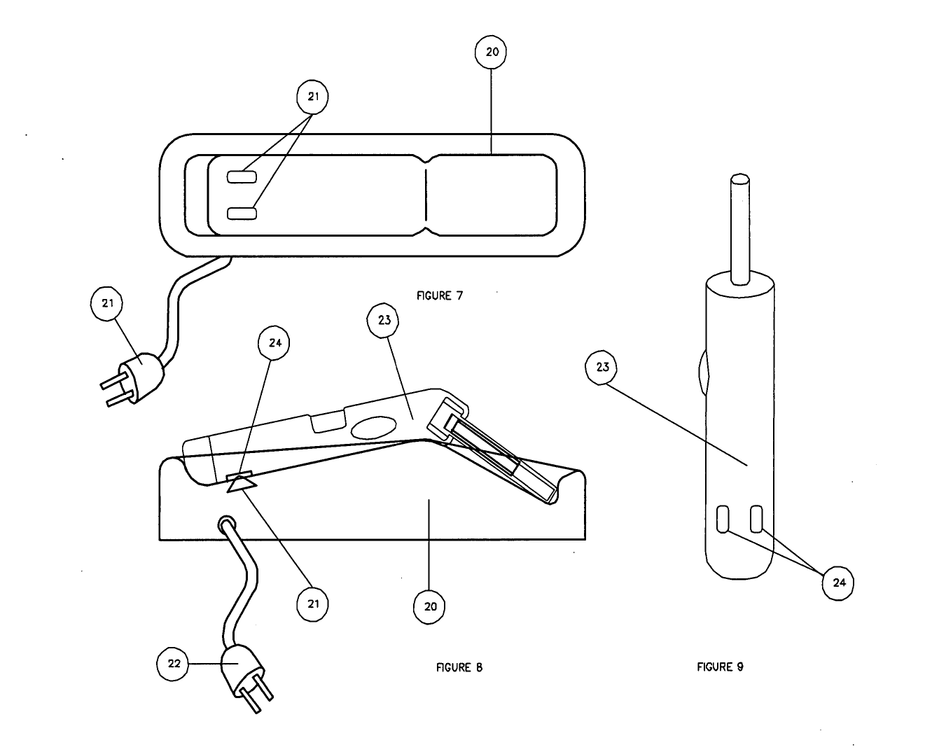

FIG. 6 shows an infrared oral thermometer having a pivoting probe 2. The probe may be pivoted between a fully extended position 16 through intermediate positions 17 and 18 and finally to a fully retracted position 19. The probe can be stored, in its fully retracted position 19, inside the housing of the thermometer when not in use.

FIG. 7 is a top view of a battery recharging base 20 that is configured to hold the thermometer when the thermometer is not in use. The base 20 has battery contacts 21, preferably made from metal or from other suitable battery contact material. An electric plug 22 may be attached to the base for providing an electrical power supply to the battery recharging base. The base 20 may be formed of plastic or other suitable material.

Referring to FIGS. 8 and 9, a rechargeable oral infrared thermometer 23 suitable for use with the battery recharging base 20 includes a pair of battery contacts 24. Battery contacts 24 are positioned for engagement with contacts 21 on the base 20, as shown in FIG. 8. While preferred forms of the invention have been shown and described, it will be realized that alterations and modifications may be made thereto without departing from the scope of the following claims.

1. A thermometer comprising:
a housing constructed to be held by a user;
a probe, extending from the housing, having an insertable portion constructed for insertion into the mouth of a patient;
an infrared sensor, mounted on the probe, for obtaining data indicative of the patient's temperature; and
a spacer, surrounding the insertable portion of the probe, the spacer being configured to preset the distance from the infrared sensor to the oral hot spot of the patient.

2. The thermometer of claim 1 further comprising a metal tube extending from a first end adjacent the sensor to a second end between the sensor and an end of the insertable portion.

3. The thermometer of claim 2 wherein the length of the spacer, measured from the second end of the tube to the end of the insertable portion, is from about 6 to 30 mm.

4. The thermometer of claim 1 wherein the spacer is formed of a clear plastic.

5. The thermometer of claim 4 wherein the spacer is formed of polycarbonate.

6. The thermometer of claim 1 wherein the total length of the thermometer inserted into the patient's mouth during use is about 40 to 60 mm.

7. The thermometer of claim 1 wherein outer diameter of the spacer is from about 4 to 12 mm.

8. The thermometer of claim 1 wherein the spacer has an angled tip.

9. A method of measuring the temperature of a patient, comprising:
providing a thermometer including (a) a probe having an insertable portion constructed for insertion into the mouth of the patient, (b) an infrared sensor, mounted on the probe, for obtaining data indicative of the patient's temperature, and (c) a spacer, surrounding the insertable portion of the probe, the spacer being configured to preset the distance from the infrared sensor to the oral hot spot of the patient; and
inserting the insertable portion into the mouth of hte patient.

10. The method of claim 9 wherein the thermometer further includes a digital display that displays the data obtained by the sensor.

11. The method of claim 10 further comprising the step of reading the temperature displayed on the digital display.
